(19) United States
(12) Patent Application Publication
(10) Pub. No.: US 2010/0282732 A1
(43) Pub. Date: Nov. 11, 2010

(54) OVEN FOR A COOKING APPLIANCE AND A METHOD FOR PERFORMING A COOKING PROCESS

(75) Inventor: Thomas Fich Pedersen, Rothenburg (DE)

Correspondence Address: PEARNE & GORDON LLP, 1801 EAST 9TH STREET, SUITE 1200, CLEVELAND, OH, 44114-3108, US

(73) Assignee: ELECTROLUX HOME PRODUCTS CORPORATION N.V., Zaventem (BE)

(21) Appl. No.: 12/669,506

(22) PCT Filed: Jun. 11, 2008
(86) PCT No.: PCT/EP08/04660

§ 371 Date: Jul. 20, 2010

(30) Foreign Application Priority Data
Jul. 20, 2007 (EP) 07014307.8

(51) Int. Cl. A21B 1/00

(52) U.S. Cl. 219/412; 219/391

(57) ABSTRACT

The invention relates to an oven for a cooking appliance, in particular for a household cooking appliance, wherein said oven (10) comprises at least one oven cavity and at least one heating element (22, 24, 26, 28). At least a part of the inner surface of the oven cavity is coated with a layer. According to the invention the layer comprises a material including a hybrid of a fluoropolymer and a glass phase. Further, the invention relates to a method for performing a cooking process with an oven (10) comprising at least one oven cavity and at least one heating element (22, 24, 26, 28). At least a part of the inner surface of the oven cavity is coated with a layer. According to the invention the method is provided to control the heating elements (22, 24, 26, 28) according to a predetermined time scheme in order to avoid a damage or a destruction of the layer.

The present invention relates to an oven for a cooking appliance according to the preamble of claim 1. Further, the present invention relates to a method for performing a cooking process according to the preamble of claim 12.

Cooking appliances like ovens are difficult to clean. The high temperatures in the cavity of the oven effect that rests of the foodstuff stick to the inner surface of the cavity. The conventional standard oven includes a cavity made of mild steel. Said steel is coated with enamel on the inner side. The enamel provides a sanitary surface and protects the steel from corrosion. The set air temperature inside the oven is up to 300° C. The most recipes require a temperature setting in the range of about 180° C. to 230° C. After cooking at these temperatures many types of foodstuff will stick very hard to the standard enamel.

There are different ways to improve the cleanability of the oven. In the prior art several attempts have been made in order to improve the cleanability of the inner surface of the oven.

In a pyrolysis oven the oven cavity is heated to a temperature of about 500° C. The foodstuff on the inner surface is simply burnt to carbon residues. Said carbon residues can be removed in a simple way. However, this process requires a very good insulation of the oven cavity and special materials within the oven. Further security means are required in order to avoid an opening of the oven, when it is hot.

Another method to improve the cleanability is either to replace the enamel surface by a coating made of a material with a low surface tension or to put on an additional coating of said material onto the enamel. This material can be a fluoropolymer like PTFE or a silicone based polymer. Further, this material can be a hybrid material of said polymer and a glass phase to increase the temperature and scratch resistance. However, the usual heating elements in a household oven produce regions on the walls of the oven cavity with high temperatures. These regions are very close to the heating elements. The temperatures in these regions exceed the maximum temperature for the above polymer. Thus, the non-stick effect will be destroyed.

Further, the standard enamel can be replaced by catalytic enamel. The catalytic enamel can disintegrate the burnt foodstuff to CO₂ by catalysis at a temperature of about 300° C. However, the catalytic enamel has a porous structure and the tendency to saturate, if larger quantities of oil and fat are spilled on it. It is not easy to clean the rough surface, when the material has been saturated.

The cleanability can also be improved by enamel with a very smooth surface and a high acid resistance. In this the cooking temperature has to be limited in order to avoid a burning in of the foodstuff residues.

It is an object of the present invention to provide an oven for a cooking appliance and a method for performing a cooking process, which improve the cleanability of the inner surfaces of the oven cavity.

This object is achieved by the oven according to claim 1.

According to the present invention the layer comprises a material including a hybrid of a fluoropolymer and a glass phase.

The main idea of the inventive oven is the layer with the hybrid of the fluoropolymer and the glass phase on the inner surface of the oven cavity. The cleanability of the oven cavity is improved. The coating on the inner surface of the oven cavity has a very low surface tension. Therefore its cleanability is comparable to the cleanability of a PTFE surface. Most of the burnt foodstuff will not stick to the surface. Those parts of the foodstuff, which stick to the surface, may be easily removed. A soft sponge and water with to mild detergent should be enough. Further, the scratch resistance is improved.

Preferably, the layer includes a material with a surface tension smaller than 30 dyn/cm.

For example, the layer includes a material, which is designated as “RAS 318”, or another material, which is designated as “RAS 318 B”. These materials are marketed as “RealEase”. These materials are described in the international patent application document WO 01/92413 A1.

The preferred embodiment of the oven comprises at least one top heating element, at least one bottom heating element, at least one grill heating element and/or at least one ring heating element. Further the oven comprises at least one fan. The heating elements allow a plurality of operation modes for the oven.

In particular, each of the heating elements is separately controllable. For this purpose the oven may comprise at least one control unit in order to control the heating elements. This allows several temperature distributions, in particular a uniform temperature distribution.

Preferably, the control unit is provided to control the heating elements according to a predetermined time scheme. This allows creating a uniform temperature distribution within the oven cavity at a temperature, which is high enough for the cooking process.

The object of the present invention is achieved by the method according to claim 12.

According to the present invention the method is provided to control the heating elements according to a predetermined time scheme in order to avoid damages or a destruction of the layer.

This method allows a uniform temperature distribution within the oven cavity and a cooking temperature, which is still able to perform the cooking process.

Further, the method is provided to control separately at least one top heating element, at least one bottom heating element, at least one grill heating element and/or at least one ring heating element. Additionally the method is provided to control separately at least one fan. The separate control of the heating elements allows a plurality of operation modes for the oven.

A first embodiment of the method according to the invention comprises within one duty cycle the steps of:
activating the bottom heating element and the grill heating element within the first half of the duty cycle,
activating the top heating element and the ring heating element within the second half of the duty cycle, and
activating the fan during the whole duty cycle.

This embodiment is provided for pre-heating the oven and allows a uniform temperature distribution.

An alternative embodiment of the method according to the invention comprises within one duty cycle the steps of:
activating the grill heating element within the first 60% of the duty cycle,
activating the bottom heating element within the first 70% of the duty cycle,
activating the ring heating element within the last 40% of the duty cycle,
activating the top heating element within the last 30% of the duty cycle, and
activating the fan during the whole duty cycle.

This embodiment is also provided for pre-heating the oven in order to get a uniform temperature distribution.

Another embodiment of the method according to the invention comprises within one duty cycle the steps of:
activating the top heating element within the first 20% of the duty cycle,
activating the bottom heating element within the second 20% of the duty cycle,
activating the ring heating element within the last 70% of the duty cycle, and
activating the fan during the whole duty cycle.

In this embodiment a substantial part of the heat is transferred from the top heating element, the bottom heating element and the ring heating element to the foodstuff by convection. The uniform temperature distribution is also obtained.

Another embodiment of the method according to the invention comprises within one duty cycle the steps of:
activating the bottom heating element within the first 80% of the duty cycle,
activating the ring heating element within the second half of the duty cycle, and
activating the fan during the whole duty cycle.

The substantial part of the heat is also transferred by convection from the bottom heating element and the ring heating element to the foodstuff. This method allows also the uniform temperature distribution.

A next embodiment of the method according to the invention comprises within one duty cycle the steps of:
activating the fan within the first half of the duty cycle,
activating the top heating element within the second half of the duty cycle,
activating the grill heating element within the second half of the duty cycle, and
running the fan at a reduced power within the second half of the duty cycle.

This method is an example of a grill mode. Only the heating elements under the top wall of the oven cavity and the fan are activated.

A further embodiment of the method according to the invention comprises within one duty cycle the steps of:
activating the top heating element during the whole duty cycle,
activating the grill heating element during the whole duty cycle, and
running the fan at a reduced power during the whole duty cycle.

This is a further example of the grill mode. The heating elements under the top wall of the oven cavity and the fan are activated during the whole cycle.

A last embodiment of the method according to the present invention comprises within one duty cycle the steps of:
activating the grill heating element during the whole duty cycle, and
running the fan at a reduced power during the whole duty cycle.

The last embodiment of the inventive method is also a grill mode, which allows a uniform temperature distribution.

In the above embodiments all other heating elements are preferably deactivated within the corresponding times of the duty cycle.

The time of the duty cycle may be between 20 s and 60 s, in particular 48 s. This is a standard time for duty cycles.

Preferably, the above method may be provided for the oven described above.

The novel and inventive features believed to be the characteristic of the present invention are set forth in the appended claims.

The invention will be described in further detail with reference to the drawing, in which

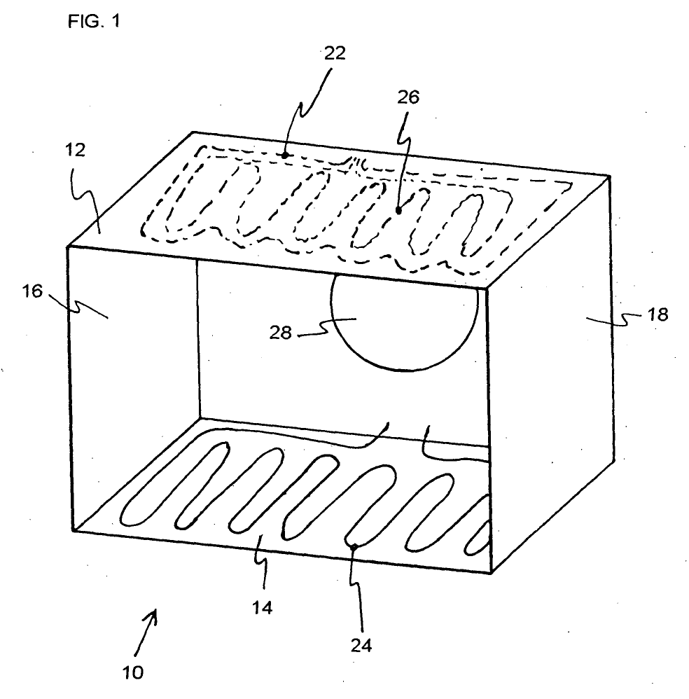

FIG. 1 illustrates a perspective view of an oven for a cooking appliance according to a preferred embodiment of the invention.

FIG. 1 illustrates a perspective view of an oven 10 for a cooking appliance according to a preferred embodiment of the invention. The oven 10 comprises a top wall 12, a bottom wall 14, a left side wall 16, a right side wall 18 and a back wall 20. Further the oven 10 comprises a front door, which is not shown in FIG. 1.

Under the top wall 12 a top heating element 22 is arranged. The top heating element 22 is an electric heating element. From the top heating element 22 to the foodstuff the heat is substantially transferred by radiation. The electric power of the top heating element 22 is about 1000 W.

Below the bottom wall 14 a bottom heating element 24 is arranged. The bottom heating element 24 is also an electric heating element. The heat from the bottom heating element 24 to the cavity room is substantially transferred by radiation and natural convection. The bottom heating element 24 is formed that its circumference covers more than 80% of the bottom surface. The electric power of the bottom heating element 24 is about 1000 W.

The distance between the bottom heating element 24 and the bottom wall 14 is more than 3 mm, in order to avoid any hot spots.

Under the top wall 12 additionally a grill heating element 26 is arranged. The grill heating element 26 is also an electric heating element and transfers the heat to the food-stuff substantially by radiation. The electric power of the grill heating element 26 in this example is about 1900 W. The grill heating element 26 is activated between 20% and 60% of the time.

In the back wall 20 a ring heating element is arranged, which is not visible in FIG. 1. The ring heating element is an electric heating element with circular form. Further, a fan 28 is arranged in the back wall 20. The ring heating element generates heat, which is blown into the cavity of the oven 10 by the fan 28. The heat from the ring heating element to the foodstuff is transferred by convection. The maximum electric power of the ring heating element in this example is about 1900 W. The average electric power of the ring heating element is about 1100 W.

On the top wall 12 a thermostat 30 is arranged. The thermostat is provided to limit the temperature under the roof of the cavity of the oven 10. In this example the limit of the temperature is about 285° C.

The inner surfaces of the top wall 12, the bottom wall 14, the side walls 16 and 18 and the back wall 20 are coated with a layer. Said layer comprises a material made of a hybrid of fluoropolymer and glass phase. An example of such a material is marketed as “RealEase” and a special version of that is designated as “RAS 318” with a top coat of another version, which is designated as “RAS 318 B”. Such materials can stand a maximum temperature of about 325° C. for a short period.

The present invention allows a maximum temperature in the oven 10, which is below this limit. The maximum setting temperature for the oven 10 is about 250° C., in order to limit the real temperature within the oven.

Additionally the present invention allows uniform temperature distribution within the oven 10. This is in particular realized by the bottom heating element 14, which has a more uniform temperature distribution than conventional heating elements. The bottom heating element 14 is arranged in a distance of more than about 3 mm from the bottom wall 14. This distance avoids hot spots.

A further aspect of the present invention is the repeatedly activation and deactivation of the top heating element 12, the bottom heating element 14, the grill heating elements 16, ring heating element and the fan 28 according to a predetermined scheme. The heating elements 22, 24, 26, the ring heating element and the fan 28 are activated and deactivated in such way, that the temperature distribution in the cavity of the oven 10 is as uniform as possible. The uniform temperature distribution allows that the temperatures of the walls 12, 14, 16, 18 and 20 are not too high on the one hand and the temperatures in the central portion of the cavity are high enough for the cooking process on the other hand.

In the following tables examples of switching patterns for the oven 10 in several operation modes are shown. The switching patterns represent the switch states of the different heating elements within a duty cycle in dependence of the time. Each heating element may be in a switch-on state or a switch-off state. The numbers in the first line refer to the percentage of the duty cycle of the heating elements. In the examples below, one duty cycle has preferably 48 seconds.

Possible kinds of operation modes are a pre-heating mode, a convection mode and a grill mode. Two examples of the pre-heating mode, two examples of the convection mode and three examples of the grill mode are described below.

The following table shows the behaviour of the different heating elements within the duty cycle in a first preheat mode PHM 1 according to the present invention.

| | PHM 1 | | | | | | | | | |
|---|---|---|---|---|---|---|---|---|---|---|
| | 10 | 20 | 30 | 40 | 50 | 60 | 70 | 80 | 90 | 100 |
| Top | off | off | off | off | off | on | on | on | on | on |
| Bottom | on | on | on | on | on | off | off | off | off | off |
| Grill | on | on | on | on | on | off | off | off | off | off |
| Ring | off | off | off | off | off | on | on | on | on | on |
| Fan | on | on | on | on | on | on | on | on | on | on |

According to the above table the top heating element 22 is switched off in the first half of the duty cycle. In the second half of the duty cycle the top heating element 22 is switched on. The bottom heating element 24 and the grill heating element 26 are switched on in the first half of the duty cycle. In the second half of the duty cycle the bottom heating element 24 and the grill heating element 26 are switched off. The ring heating element is switched off in the first half and switched on in the second half of the duty cycle. The fan 28 is switched on during the whole duty cycle.

The next table shows the behaviour of the heating elements within one duty cycle in a second preheat mode PHM 2 according to the present invention.

| | PHM 2 | | | | | | | | | |
|---|---|---|---|---|---|---|---|---|---|---|
| | 10 | 20 | 30 | 40 | 50 | 60 | 70 | 80 | 90 | 100 |
| Top | off | off | off | off | off | off | off | on | on | on |
| Bottom | on | on | on | on | on | on | on | off | off | off |
| Grill | on | on | on | on | on | on | off | off | off | off |
| Ring | off | off | off | off | off | off | on | on | on | on |
| Fan | on | on | on | on | on | on | on | on | on | on |

According to the above table the top heating element 22 is switched off and the bottom heating element 24 is switched on in the first 70% of the duty cycle. In the last 30% of the duty cycle the top heating element 22 is switched on and the bottom heating element 24 is switched off. In the first 60% of the duty cycle the grill heating element 26 is switched on and the ring heating element is switched off. In the last 40% of the duty cycle the ring heating element is switched on and the grill heating element 26 is switched off. The fan 28 is switched on during the whole duty cycle.

In the next table the behaviour of the heating elements within one duty cycle in a first convection mode CM 1 according to the present invention is shown.

| | CM 1 | | | | | | | | | |
|---|---|---|---|---|---|---|---|---|---|---|
| | 10 | 20 | 30 | 40 | 50 | 60 | 70 | 80 | 90 | 100 |
| Top | on | on | off | off | off | off | off | off | off | off |
| Bottom | off | off | on | on | off | off | off | off | off | off |
| Grill | off | off | off | off | off | off | off | off | off | off |
| Ring | off | off | off | on | on | on | on | on | on | on |
| Fan | on | on | on | on | on | on | on | on | on | on |

The top heating element 22 is switched on in the first 20% of the duty cycle and is switched off in the last 80% of the duty cycle. The bottom heating element 14 is switched s off in the first 20% and switched on in the second 20% of the duty cycle. During the last 60% of the duty cycle the bottom heating element 14 is switched off. The grill heating element 26 is switched off during the whole duty cycle. In the first 30% of the duty cycle the ring heating element is switched off and in the last 70% of the duty cycle the ring heating element is switched on. The fan 28 is switched on during the whole duty cycle.

In the following table the switch states of the heating elements within one duty cycle in a second convection mode CM 2 according to the present invention is shown.

| | CM 2 | | | | | | | | | |
|---|---|---|---|---|---|---|---|---|---|---|
| | 10 | 20 | 30 | 40 | 50 | 60 | 70 | 80 | 90 | 100 |
| Top | off | off | off | off | off | off | off | off | off | off |
| Bottom | on | on | on | on | on | on | on | on | off | off |
| Grill | off | off | off | off | off | off | off | off | off | off |
| Ring | off | off | off | off | off | on | on | on | on | on |
| Fan | on | on | on | on | on | on | on | on | on | on |

The top heating element 22 and the grill heating element 26 are switched off during the whole duty cycle. The bottom heating element 22 is switched on in the first 80% of the duty cycle and switched off in the last 20% of the duty cycle. The ring heating element is switched off in the first half of the duty cycle and switched on in the second half of the duty cycle. The fan 28 is switched on during the whole duty cycle.

In the grill modes the main part of the heat from the heating element or heating elements, respectively, to the food-stuff is transferred by radiation. According to the present invention an additional function is introduced. In the grill mode the fan 28 is activated at a speed of about 20% of the normal speed, but not more than 30% of the normal speed. The fan 28 allows that the hot air circulates in the cavity of the oven 10. Otherwise the hot air would accumulate under the roof of said cavity.

In a static mode a large part of the heat transfer between the grill heating element 26 and the roof would result from the natural convection around the grill heating element 26. Thus, in said static mode, a cloud of hot air would be built up in the upper part of the cavity, and the rest of the cavity would be heated up very slowly. Three different grill modes are described below.

The next table shows the behaviour of the heating elements within one duty cycle in a first grill mode GM 1 according to the present invention.

| | GM 1 | | | | | | | | | |
|---|---|---|---|---|---|---|---|---|---|---|
| | 10 | 20 | 30 | 40 | 50 | 60 | 70 | 80 | 90 | 100 |
| Top | off | off | off | off | off | on | on | on | on | on |
| Bottom | off | off | off | off | off | off | off | off | off | off |
| Grill | off | off | off | off | off | on | on | on | on | on |
| Ring | off | off | off | off | off | off | off | off | off | off |
| Fan | on | on | on | on | on | sf | sf | sf | sf | sf |

In the first half of the duty cycle the four heating elements are switched off and the fan 28 is switched on. In the second half of the duty cycle the top heating element 22 and the grill heating element 26 are switched on and the bottom heating element 24 and the ring heating element are switched off. The fan 28 is running at a reduced power in the second half of the duty cycle. The abbreviation “sf” in the table means “slow fan”.

The following table shows the switching states of the heating elements within one duty cycle in a second grill mode GM 2 according to the present invention.

| | GM 2 | | | | | | | | | |
|---|---|---|---|---|---|---|---|---|---|---|
| | 10 | 20 | 30 | 40 | 50 | 60 | 70 | 80 | 90 | 100 |
| Top | on | on | on | on | on | on | on | on | on | on |
| Bottom | off | off | off | off | off | off | off | off | off | off |
| Grill | on | on | on | on | on | on | on | on | on | on |
| Ring | off | off | off | off | off | off | off | off | off | off |
| Fan | sf | sf | sf | sf | sf | sf | sf | sf | sf | sf |

In the second grill mode GM 2 the top heating element 22 and the grill heating element 26 are switched on during the whole duty cycle. The bottom heating element 24 and the ring heating element are switched off during the whole duty cycle. The fan 28 is running at a reduced power during the whole duty cycle.

The last table shows the behaviour of the heating elements within one duty cycle in a third grill mode GM 3 according to the present invention.

| | GM 3 | | | | | | | | | |
|---|---|---|---|---|---|---|---|---|---|---|
| | 10 | 20 | 30 | 40 | 50 | 60 | 70 | 80 | 90 | 100 |
| Top | off | off | off | off | off | off | off | off | off | off |
| Bottom | off | off | off | off | off | off | off | off | off | off |
| Grill | on | on | on | on | on | on | on | on | on | on |
| Ring | off | off | off | off | off | off | off | off | off | off |
| Fan | sf | sf | sf | sf | sf | sf | sf | sf | sf | sf |

In the third grill mode CM 3 the top heating element 22, the bottom heating element 24 and the ring heating element are switched off and the grill heating element 26 is switched on during the whole duty cycle. The fan 28 is running at a reduced power during the whole duty cycle. This is especially advantageous, when the oven 10 is not pre-heated.

The oven 10 according to the present invention comprises an easy cleanable inner surface. The method according to the present invention creates a uniform temperature distribution within the oven cavity. Thus, the method allows a cooking process without too high temperatures on the inner surfaces of the cavity in the oven 10. This method avoids damages or a destruction of the layer on the inner surface of the oven 10.

### LIST OF REFERENCE NUMERALS

10 oven

12 top wall

14 bottom wall

16 left side wall

18 right side wall

20 back wall

22 top heating element

24 bottom heating element

26 grill heating element

28 fan

PHM 1 first pre-heating mode

PHM 2 second pre-heating mode

CM 1 first convection mode

CM 2 second convection mode

GM 1 first grill mode

GM 2 second grill mode

GM 3 third grill mode

1. An oven for a cooking appliance, in particular for a household cooking appliance, wherein said oven (10) comprises at least one oven cavity and at least one heating element (22, 24, 26, 28), and wherein at least a part of the inner surface of the oven cavity is coated with a layer, characterized in, that the layer comprises a material including a hybrid of a fluoropolymer and a glass phase.

2. The oven according to claim 1, characterized in, that the layer includes a material with a with a surface tension smaller than 30 dyn/cm.

3. The oven according to claim 1, characterized in, that the layer includes a material, which is designated as “RAS 318” and/or as “RAS 318 B”.

4. The oven according to claim 1, characterized in, that the oven (10) comprises at least one top heating element (22).

5. The oven according to claim 1, characterized in, that the oven (10) comprises at least one bottom heating element (24).

6. The oven according to claim 1, characterized in, that the oven (10) comprises at least one grill heating element (26).

7. The oven according to claim 1, characterized in, that the oven (10) comprises at least one ring heating element.

8. The oven according to claim 1, characterized in, that the oven (10) comprises at least one fan (28).

9. The oven according to claim 1, characterized in, that each of the heating elements (22, 24, 26, 28) is separately controllable.

10. The oven according to claim 1, characterized in, that the oven (10) comprises at least one control unit in order to control the heating elements (22, 24, 26, 28).

11. The oven according to claim 10, characterized in, that the control unit is provided to control the heating elements (22, 24, 26, 28) according to a predetermined time scheme.

12. A method for performing a cooking process with an oven (10) comprising at least one oven cavity and at least one heating element (22, 24, 26, 28), wherein at least a part of the inner surface of the oven cavity is coated with a layer, characterized in, that the method is provided to control the heating elements (22, 24, 26, 28) according to a predetermined time scheme in order to avoid damages or a destruction of the layer.

13. The method according to claims 12, characterized in, that the method is provided to control separately at least one top heating element (22).

14. The method according to claim 12, characterized in, that the method is provided to control separately at least one bottom heating element (24).

15. The method according to claim 12, characterized in, that the method is provided to control separately at least one grill heating element (26).

16. The method according to claim 12, characterized in, that the method is provided to control separately at least one ring heating element.

17. The method according to claim 12, characterized in, that the method is provided-to control separately at least one fan (28).

18. The method according to claim 12, characterized in, that the method comprises within one duty cycle the steps of:
activating the bottom heating element (24) and the grill heating element (26) within the first half of the duty cycle,
activating the top heating element (22) and the ring heating element within the second half of the duty cycle, and
activating the fan (28) during the whole duty cycle.

19. The method according to claim 12, characterized in, that the method comprises within one duty cycle the steps of:
activating the grill heating element (26) within the first 60% of the duty cycle,
activating the bottom heating element (24) within the first 70% of the duty cycle,
activating the ring heating element within the last 40% of the duty cycle,
activating the top heating element (22) within the last 30% of the duty cycle, and
activating the fan (28) during the whole duty cycle.

20. The method according to claim 12, characterized in, that the method comprises within one duty cycle the steps of:
activating the top heating element (22) within the first 20% of the duty cycle,
activating the bottom heating element (24) within the second 20% of the duty cycle,
activating the ring heating element within the last 70% of the duty cycle, and
activating the fan (28) during the whole duty cycle.

21. The method according to claim 12, characterized in, that the method comprises within one duty cycle the steps of:
activating the bottom heating element (24) within the first 80% of the duty cycle,
activating the ring heating element within the second half of the duty cycle, and
activating the fan (28) during the whole duty cycle.

22. The method according to claim 12, characterized in, that the method comprises within one duty cycle the steps of:
activating the fan (28) within the first half of the duty cycle,
activating the top heating element (22) within the second half of the duty cycle,
activating the grill heating element (26) within the second half of the duty cycle, and
running the fan (28) at a reduced power within the second half of the duty cycle.

23. The method according to claim 12, characterized in, that the method comprises within one duty cycle the steps of:
activating the top heating element (22) during the whole duty cycle,
activating the grill heating element (26) during the whole duty cycle, and
running the fan (28) at a reduced power during the whole duty cycle.

24. The method according to claim 12, characterized in, that the method comprises within one duty cycle the steps of:
activating the grill heating element (26) during the whole duty cycle, and
running the fan (28) at a reduced power during the whole duty cycle.

25. The method according to claim 18, characterized in, that all other heating elements (22, 24, 26, 28) are deactivated within the corresponding times of the duty cycle.

26. The method according to claim 18, characterized in, that the time of the duty cycle is between 30 s and 60 s, in particular 48 s.

27. (canceled)
